(19) United States
(12) Patent Application Publication
(10) Pub. No.: US 2023/0326667 A1
(43) Pub. Date: Oct. 12, 2023

(54) COIL COMPONENT

(71) Applicant: TDK Corporation, Tokyo (JP)

(72) Inventors: Yuki HASHIMOTO, Tokyo (JP); Toshiyuki ABE, Tokyo (JP); Takeshi OKUMURA, Tokyo (JP); Masanori SUZUKI, Tokyo (JP)

(21) Appl. No.: 18/183,516

(22) Filed: Mar. 14, 2023

(30) Foreign Application Priority Data
Mar. 30, 2022 (JP) 2022-056998

(51) Int. Cl. H01F 27/24; H01F 27/32; H01F 27/29

(52) U.S. Cl. CPC H01F 27/292; H01F 27/24; H01F 27/323

(57) ABSTRACT

Disclosed herein is a coil component that includes: a coil part including a coil conductor embedded in the magnetic element body and a bump electrode embedded in the magnetic element body through a second insulating resin layer and connected to an end portion of a coil conductor. A side surface of the bump electrode at a mounting surface is covered with the second insulating resin layer. The second insulating resin layer covering the side surface of the bump electrode has a first area having a first width in a planar direction parallel with the mounting surface and a second area having a second width in the planar direction larger than the first width.

### BACKGROUND OF THE ART

### --Field of the Art

The present disclosure relates to a coil component and, more particularly, to a coil component having a structure in which a coil part and a bump electrode are embedded in a magnetic element body.

### --Description of Related Art

JP 2021-052076 discloses a coil component having a structure in which a coil part and a bump electrode are embedded in a magnetic element body. Embedding the coil part in the magnetic element body can achieve high inductance.

However, a magnetic element body has a dielectric contact higher than that of a typical resin material, so that there poses such a problem that the higher the height of a bump electrode embedded in the magnetic element body is, the larger a stray capacitance to be added to the bump electrode becomes.

### SUMMARY

It is therefore an object of the present disclosure to provide a coil component having a structure in which a coil part and a bump electrode are embedded in a magnetic element body, capable of reducing a stray capacitance to be added to the bump electrode.

A coil component according to the present disclosure includes: a magnetic element body, a coil part embedded in the magnetic element body, having a structure in which a plurality of conductor layers each including a coil pattern and a plurality of first insulating resin layer made of a material having a dielectric constant lower than that of the magnetic element body are alternately stacked, and a bump electrode embedded in the magnetic element body through a second insulating resin layer and connected to the end portion of a coil conductor constituted of the plurality of coil patterns. The side surface of the bump electrode at the mounting surface is covered with the second insulating resin layer, and the second insulating resin layer covering the side surface of the bump electrode has a first area having a first width in the planar direction and a second area having a second width in the planar direction larger than the first width.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic perspective view illustrating the outer appearance of a coil component 1 according to a first embodiment of the present disclosure;

FIG. 2 is a schematic cross-sectional view taken along the line A-A in FIG. 1;

FIG. 3 is a schematic plan view of the coil component 1;

FIG. 4 is a schematic plan view illustrating the planar shape of the conductor layer 10;

FIG. 5 is a schematic plan view illustrating the planar shapes of the conductor layers 20, 40, and 60;

FIG. 6 is a schematic plan view illustrating the planar shapes of the conductor layers 30 and 50;

FIG. 7 is a graph for explaining the effect of the coil component 1;

FIG. 8 is a schematic cross-sectional view for explaining the structure of a coil component 2 according to a second embodiment of the present disclosure;

FIG. 9 is a schematic plan view of the coil component 2;

FIG. 10 is a schematic cross-sectional view for explaining the structure of a coil component 3 according to a third embodiment of the present disclosure; and

FIG. 11 is a schematic plan view of the coil component 3.

### DETAILED DESCRIPTION OF THE EMBODIMENTS

Preferred embodiments of the present disclosure will be explained below in detail with reference to the accompanying drawings.

### First Embodiment

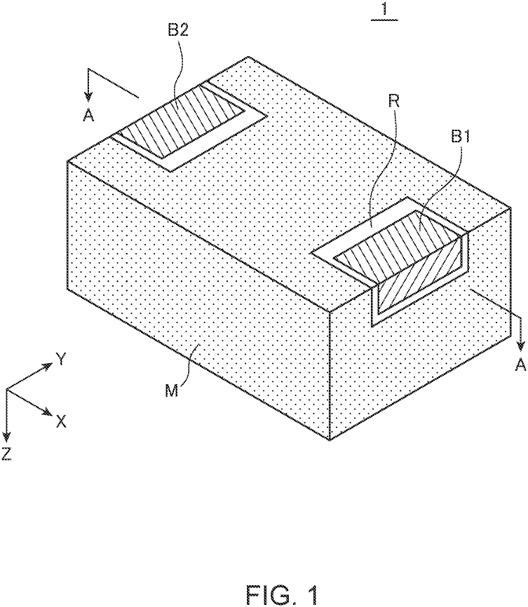

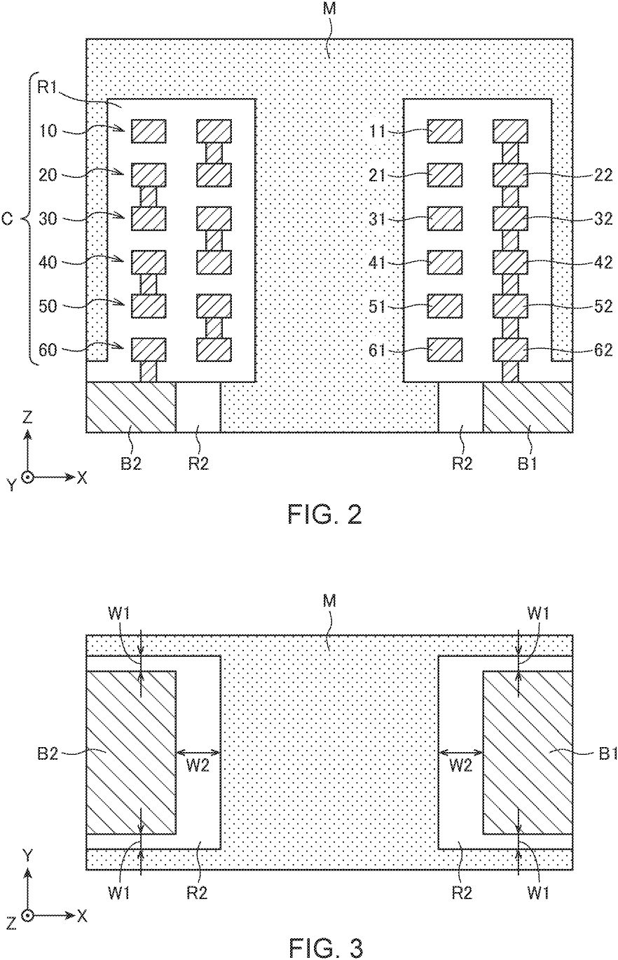

FIG. 1 is a schematic perspective view illustrating the outer appearance of a coil component 1 according to a first embodiment of the present disclosure. FIG. 2 is a schematic cross-sectional view taken along the line A-A in FIG. 1, and FIG. 3 is a schematic plan view of the coil component 1.

The coil component 1 according to the present embodiment is a surface-mount type chip component and includes, as illustrated in FIGS. 1 to 3, a magnetic element body M, a coil part C, and a pair of bump electrodes B1 and B2. The coil part C and bump terminal electrodes B1 and B2 are embedded in the magnetic element body M. The bump electrodes B1 and B2 are each embedded in the magnetic element body M through an insulating resin layer R and thus do not contact the magnetic element body M. The insulating resin layer R may be made of a single material or, as will be described later, may be constituted by insulating resin layers R1 and R2 made of different materials. Although the configuration of the coil part C will be described later, in the present embodiment, six conductor layers each having a spiral conductor coil pattern are stacked to form one coil conductor. One end of the coil conductor is connected to the bump electrode B1, and the other end thereof is connected to the bump electrode B2. The coil pattern need not necessarily be a spiral pattern and may have any other shape.

The magnetic element body M is a composite magnetic member containing magnetic metal filler made of iron (Fe) or a permalloy-based material and a resin binder and forms a magnetic path for magnetic flux generated by making a current flow in the coil conductor. The resin binder is preferably formed of an epoxy resin in the form of liquid or powder. The magnetic element body M may be constituted by a single composite magnetic member or two or more different types of composite magnetic materials.

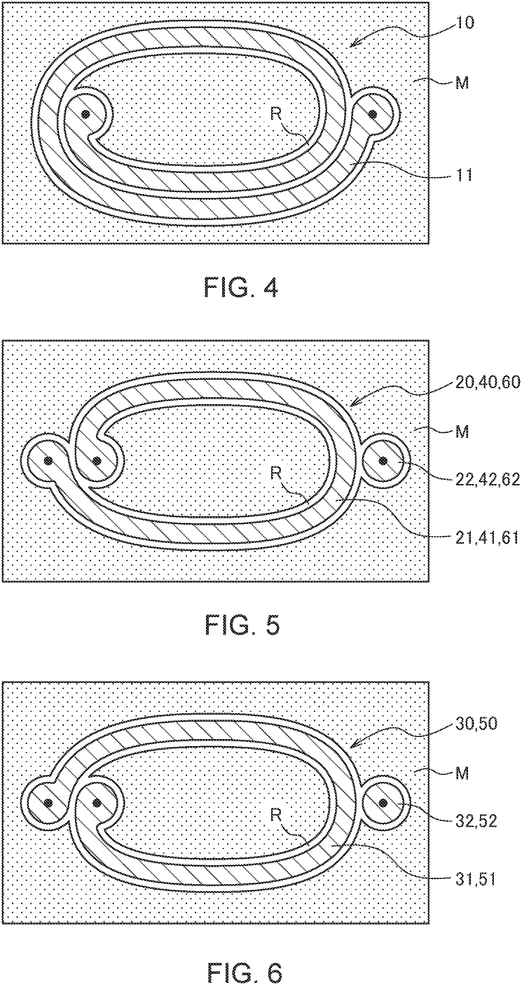

As illustrated in FIG. 2, the coil part C has a structure in which the insulating resin layer R1 and conductor layers 10, 20, 30, 40, 50, and 60 are alternately stacked in a coil axial direction (Z-direction). The planar shape of the conductor layer 10 is illustrated in FIG. 4, the planer shape of the conductor layers 20, 40, and 60 is illustrated in FIG. 5, and the planar shape of the conductor layers 30 and 50 is illustrated in FIG. 6. The conductor layers 10, 20, 30, 40, 50, and 60 have spiral patterns 11, 21, 31, 41, 51, and 61, respectively. The surfaces of the respective spiral patterns 11, 21, 31, 41, 51, and 61 are covered with the insulating resin layer R1 and are thus prevented from contacting the magnetic element body M.

The spiral patterns 11, 21, 31, 41, 51, and 61 are connected to one another through via holes formed in the insulating resin layer R1 to constitute one coil conductor. The conductor layers 10, 20, 30, 40, 50, and 60 are preferably made of copper (Cu). The insulating resin layer R1 is not particularly limited in material and is made of a resin material having a dielectric constant lower than that of at least the magnetic element body M.

The conductor layer 10 is the first conductor layer and has a spiral pattern 11 spirally wound in about 1.5 turns, as illustrated in FIG. 4. The conductor layers 20, 30, 40, 50, and 60 are the second to sixth conductor layers stacked on the conductor layer 10 through the insulating resin layer R1 and have, respectively, spiral patterns 21, 31, 41, 51, and 61 each spirally wound in about one turn and connection patterns 22, 32, 42, 52, and 62, as illustrated in FIGS. 5 and 6. The connection patterns 22, 32, 42, 52, and 62 are provided independently of the spiral patterns 21, 31, 41, 51, and 61 within the respective surfaces.

The outer peripheral end of the spiral pattern 11 is connected to the bump electrode B1 through the connection patterns 22, 32, 42, 52, and 62. Further, the inner peripheral ends of the respective spiral patterns 11 and 21 are mutually connected, the outer peripheral ends of the respective spiral patterns 21 and 31 are mutually connected, the inner peripheral ends of the respective spiral patterns 31 and 41 are mutually connected, the outer peripheral ends of the respective spiral patterns 41 and 51 are mutually connected, the inner peripheral ends of the respective spiral patterns 51 and 61 are mutually connected, and the outer peripheral end of the spiral pattern 61 is connected to the bump electrode B2. As a result, a coil conductor of about 6.5 turns is connected between the bump electrodes B1 and B2. The bump electrodes B1 and B2 are each a post-shaped conductor having a thickness in the Z-direction larger than those of the conductor layers 10, 20, 30, 40, 50, and 60. Like the conductor layers 10, 20, 30, 40, 50, and 60, the bump electrodes B1 and B2 are preferably made of copper (Cu).

In the present embodiment, the bump electrodes B1 and B2 embedded in the magnetic element body M are used as a pair of external terminals. The exposed surface of each of the bump electrodes B1 and B2 may be covered with an alloy containing Sn. As illustrated in FIG. 1, in the present embodiment, the bump electrodes B1 and B2 are exposed to the XY surface which is a mounting surface and to the YZ surface perpendicular to the mounting surface, thereby each constituting a so-called L-shaped electrode.

As illustrated in FIG. 3, the side surface of each of the bump electrodes B1 and B2 in the XY surface direction perpendicular to the Z-direction as the axial direction of the coil part C is covered with the insulating resin layer R2. The insulating resin layer R2 covering the side surfaces of the bump electrodes B1 and B2 is not uniform in width in the planar direction but has a small-width area and a large-width area. In the example illustrated in FIG. 3, a width W2 of the insulating resin layer R2 positioned at the X-direction side of the bump electrodes B1 and B2 is larger than a width W1 of the insulating resin layer R2 positioned at the Y-direction side of the bump electrodes B1 and B2. The X-direction corresponds to the arrangement direction of the bump electrodes B1 and B2. When the width W1 or W2 is not constant, any one of the smallest width and the average width thereof may be defined as the width W1 or W2.

With the above configuration, the distance between each of the bump electrodes B1, B2 and the magnetic element body M adjacent thereto in the X-direction increases as compared to when the entire width of the insulating resin layer R2 covering the side surfaces of the bump electrodes B1 and B2 is set to W1, so that a stray capacitance to be added to the bump electrodes B1 and B2 decreases. In addition, the X-direction is the arrangement direction of the bump electrodes B1 and B2, so that a capacitance component generated between the bump electrodes B1 and B2 also decreases. Such an effect becomes prominent as the height of the bump electrodes B1 and B2 in the Z-direction increases. Further, the volume of the magnetic element body M increases as compared to when the entire width of the insulating resin layer R2 covering the side surfaces of the bump electrodes B1 and B2 is set to W2, allowing a sufficient inductance to be ensured. The insulating resin layers R1 and R2 may be made of the same material; however, when the insulating resin layer R2 is made of a material having a dielectric constant lower than that of the insulating resin layer R1, the stray capacitance for the bump electrodes B1 and B2 further decreases.

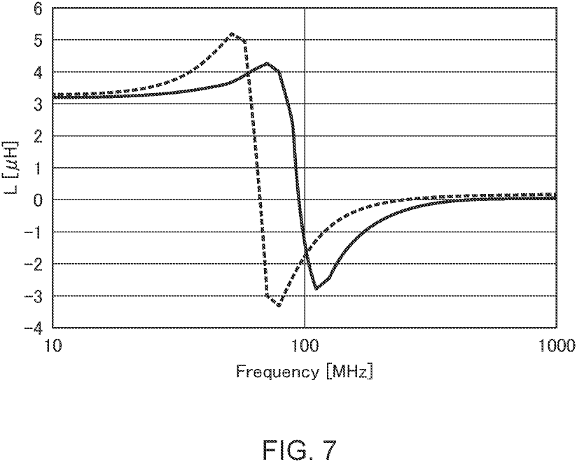

FIG. 7 is a graph for explaining the effect of the coil component 1 according to the present embodiment. The horizontal axis represents a frequency, and the vertical axis represents an inductance. In FIG. 7, the solid line indicates the characteristics of the coil component 1 according to the present embodiment, and the dashed line indicates the characteristics of a coil component according to a comparative example. The coil component according to the comparative example has a structure obtained by setting the entire width of the insulating resin layer R2 covering the side surfaces of the bump electrodes B1 and B2 to W1 in the coil component 1 according to the present embodiment. As can be seen from FIG. 7, the resonance frequency in the coil component according to the comparative example is about 65 MHz, while the resonance frequency in the coil component 1 according to the present embodiment is about 95 MHz, that is, the coil component according to the present embodiment is improved in high frequency characteristics.

### Second Embodiment

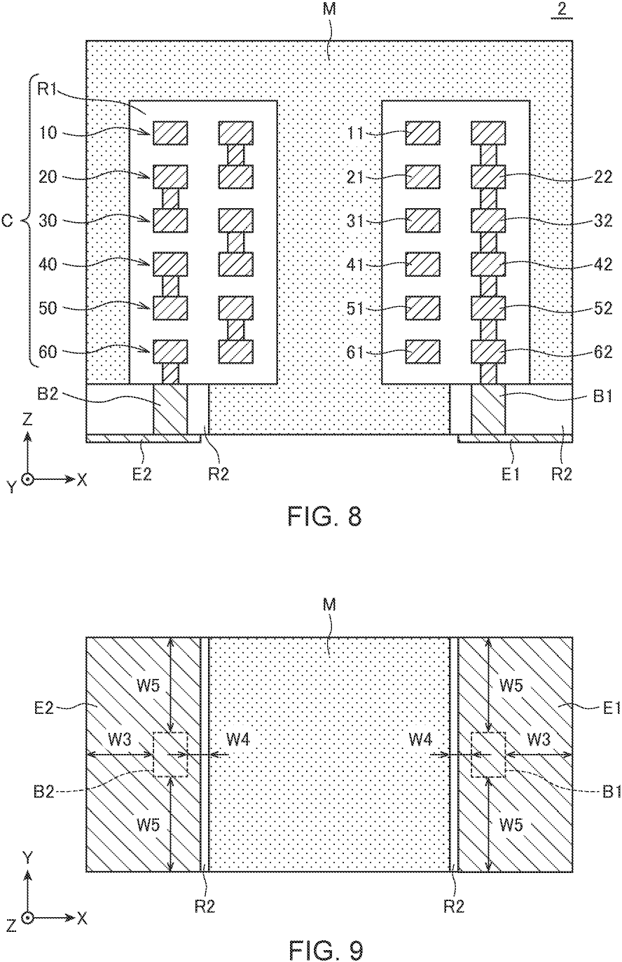

FIG. 8 is a schematic cross-sectional view for explaining the structure of a coil component 2 according to a second embodiment of the present disclosure. FIG. 9 is a schematic plan view of the coil component 2.

As illustrated in FIGS. 8 and 9, the coil component 2 according to the second embodiment differs from the coil component 1 according to the first embodiment in that the bump electrodes B1 and B2 are reduced in planar size and that electrode patterns E1 and E2 covering respectively the bump electrodes B1 and B2 in the Z-direction are additionally provided. Other basic configurations are the same as those of the coil component 1 according to the first embodiment, so the same reference numerals are given to the same elements, and overlapping description will be omitted.

In the present embodiment, the bump electrode B1 is provided only immediately below the connection pattern 62 and in the vicinity thereof, and the bump electrode B2 is provided only immediately below the outer peripheral end of the spiral pattern 61 and in the vicinity thereof. Accordingly, the bump electrodes B1 and B2 are not exposed from the YZ surface of the magnetic element body M and exposed only from the XY surface. The exposed XY surfaces of the bump electrodes B1 and B2 are connected respectively to the electrode patterns E1 and E2. The electrode patterns E1 and E2 are each made of a conductive paste containing metal powder and resin. The electrode patterns E1 and E2 do not contact the magnetic element body M, and parts of the electrode patterns E1 and E2 that do not contact respectively the bump electrodes B1 and B2 entirely contact the insulating resin layer R2.

The bump electrodes B1 and B2 are reduced in size especially in the Y-direction, with the result that a width W5 of the insulating resin layer R2 positioned at the Y-direction side of the bump electrodes B1 and B2 is larger than widths W3 and W4 of the insulating resin layer R2 positioned at the X-direction side of the bump electrodes B1 and B2. This reduces the opposing area between the bump electrodes B1 and B2 to thereby reduce a capacitance component generated therebetween. Further, the bump electrodes B1 and B2 are reduced in size also in the X-direction, so that they do not overlap a part of the magnetic element body M that is positioned radially outside the coil part C. This also reduces a stray capacitance caused due to overlap in the Z-direction between the bump electrodes B1, B2 and the magnetic element body M.

Further, in the present embodiment, when comparing the widths W3 and W4 of the insulating resin layer R2 positioned at the X-direction side of the bump electrodes B1 and B2, the width W3 of the area positioned outside the bump electrodes B1 and B2 is larger than the width W4 of the area positioned between the bump electrodes B1 and B2. Thus, even though the exposed areas of the respective bump electrodes B1 and B2 are significantly reduced, the areas of the respective electrode patterns E1 and E2 can be sufficiently ensured.

### Third Embodiment

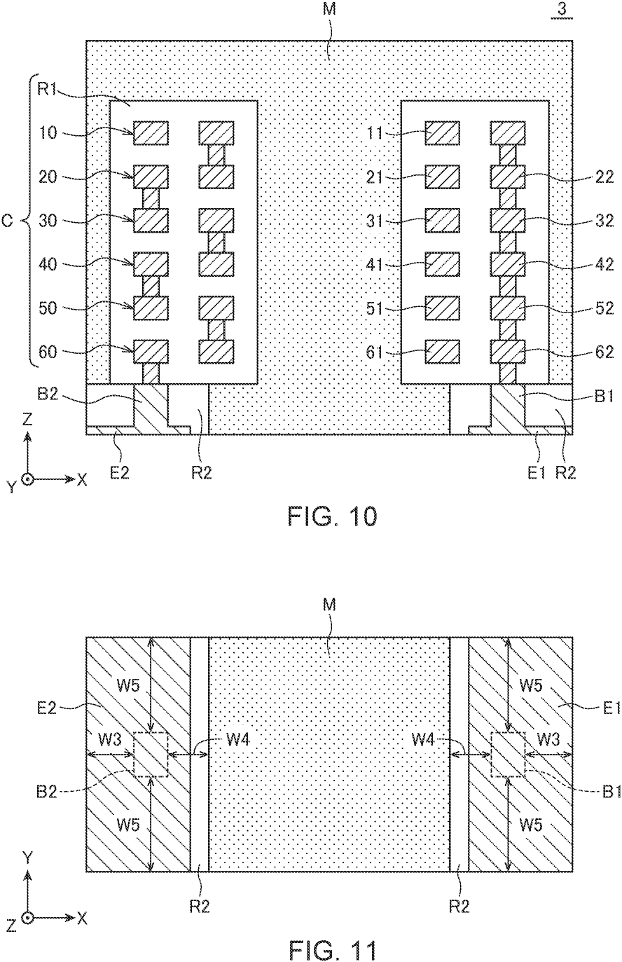

FIG. 10 is a schematic cross-sectional view for explaining the structure of a coil component 3 according to a third embodiment of the present disclosure. FIG. 11 is a schematic plan view of the coil component 3.

As illustrated in FIGS. 10 and 11, the coil component 3 according to the third embodiment differs from the coil component 2 according to the second embodiment in that the electrode patterns E1 and E2 are embedded in the insulating resin layer R2 and integrated respectively with the bump electrodes B1 and B2. Further, the surfaces of the respective electrode patterns E1 and E2 are substantially flush with the surface of the insulating resin layer R2 by surface treatment such as polishing. Other basic configurations are the same as those of the coil component 2 according to the second embodiment, so the same reference numerals are given to the same elements, and overlapping description will be omitted.

In the present embodiment, the electrode patterns E1, E2 and bump electrodes B1, B2 are made of the same material. Further, like the coil component 2 according to the second embodiment, the width W5 of the insulating resin layer R2 positioned at the Y-direction side of the bump electrodes B1 and B2 is larger than the widths W3 and W4 of the insulating resin layer R2 positioned at the X-direction side of the bump electrodes B1 and B2. This reduces a capacitance component generated between the bump electrodes B1 and B2. Further, since the electrode patterns E1, E2 and bump electrodes B1, B2 are made of the same material, a DC resistance can be reduced more than in the coil component 2 according to the second embodiment.

While the preferred embodiment of the present disclosure has been described, the present invention is not limited to the above embodiment, and various modifications may be made within the scope of the present disclosure, and all such modifications are included in the present disclosure.

For example, although a single coil part C is embedded in the magnetic element body M in the above embodiment, the present disclosure may be applicable to a so-called array product having a structure in which a plurality of coil parts C are embedded in the magnetic element body M.

The technology according to the present disclosure includes the following configuration examples but not limited thereto.

A coil component according to the present disclosure includes: a magnetic element body, a coil part embedded in the magnetic element body, having a structure in which a plurality of conductor layers each including a coil pattern and a plurality of first insulating resin layer made of a material having a dielectric constant lower than that of the magnetic element body are alternately stacked, and a bump electrode embedded in the magnetic element body through a second insulating resin layer and connected to the end portion of a coil conductor constituted of the plurality of coil patterns. The side surface of the bump electrode at the mounting surface is covered with the second insulating resin layer, and the second insulating resin layer covering the side surface of the bump electrode has a first area having a first width in the planar direction and a second area having a second width in the planar direction larger than the first width.

According to the present disclosure, a part of the side surface of the bump electrode is covered with the insulating resin layer having a large width, so that a stray capacitance to be added to the bump electrode can be reduced.

In the present disclosure, the bump electrode may include a first bump electrode connected to the one end of the coil conductor and a second bump electrode connected to the other end of the coil conductor, and the second area of the second insulating resin layer may be positioned between the first and second bump electrodes. This reduces the volume of the magnetic element body positioned between the first and second bump electrodes and, correspondingly, the volume of the insulating resin layer increases, thereby making it possible to reduce a capacitance component generated between the first and second bump electrodes.

In the present disclosure, the bump electrode may include a first bump electrode connected to one end of the coil part and a second bump electrode connected to the other end of the coil part, the first and second bump electrodes may be covered respectively with first and second electrode patterns in the direction perpendicular to the mounting surface, and the second area of the second insulating resin layer may be positioned on the side of each of the first and second bump electrodes in a direction perpendicular to the arrangement direction thereof. This reduces the opposing area between the first and second bump electrodes, thereby making it possible to reduce a capacitance component generated between the first and second bump electrodes.

In this case, the first and second bump electrodes need not overlap a part of the magnetic element body that is positioned radially outside the coil part. This can reduce a stray capacitance caused due to overlap between the bump electrode and the magnetic element body.

In the present disclosure, the first and second electrode patterns need not contact the magnetic element body. This can reduce a stray capacitance to be added to the first and second electrode patterns.

In the present disclosure, the second insulating resin layer may have a dielectric constant lower than that of the first insulating resin layer. This can further reduce a stray capacitance to be added to the bump electrode.

As described above, according to the present disclosure, there can be provided a coil component having a structure in which a coil part and a bump electrode are embedded in a magnetic element body, capable of reducing a stray capacitance to be added to the bump electrode.

What is claimed is:

1. A coil component comprising:
a magnetic element body;
a coil part embedded in the magnetic element body, the coil part having a structure in which a plurality of conductor layers each including a coil pattern and a plurality of first insulating resin layers made of a material having a dielectric constant lower than that of the magnetic element body are alternately stacked; and
a bump electrode embedded in the magnetic element body through a second insulating resin layer and connected to an end portion of a coil conductor constituted of the plurality of coil patterns,
wherein a side surface of the bump electrode at a mounting surface is covered with the second insulating resin layer, and
wherein the second insulating resin layer covering the side surface of the bump electrode has a first area having a first width in a planar direction parallel with the mounting surface and a second area having a second width in the planar direction larger than the first width.

2. The coil component as claimed in claim 1,
wherein the bump electrode includes a first bump electrode connected to the one end of the coil conductor and a second bump electrode connected to other end of the coil conductor, and
wherein the second area of the second insulating resin layer is positioned between the first and second bump electrodes.

3. The coil component as claimed in claim 1,
wherein the bump electrode includes a first bump electrode connected to the one end of the coil conductor and a second bump electrode connected to other end of the coil conductor,
wherein the first and second bump electrodes are covered respectively with first and second electrode patterns in a direction perpendicular to the mounting surface, and
wherein the second area of the second insulating resin layer is positioned on a side of each of the first and second bump electrodes in a direction perpendicular to the arrangement direction thereof.

4. The coil component as claimed in claim 3, wherein the first and second bump electrodes do not overlap a part of the magnetic element body that is positioned radially outside the coil part.

5. The coil component as claimed in claim 3, wherein the first and second electrode patterns do not contact the magnetic element body.

6. The coil component as claimed in claim 1, wherein the second insulating resin layer has a dielectric constant lower than that of the first insulating resin layer.

7. A coil component having a mounting surface, the coil component comprising:
a magnetic element body;
a coil conductor embedded in the magnetic element body;
a first electrode connected to a first end of the coil conductor;
a second electrode connected to a second end of the coil conductor;
a first insulating resin layer arranged between the first electrode and the magnetic element body in the mounting surface; and
a second insulating resin layer arranged between the second electrode and the magnetic element body in the mounting surface,
wherein the first and second electrodes are arranged in a first direction in the mounting surface,
wherein a first width of the first and second insulating resin layers in the first direction in the mounting surface is greater than a second width of the first and second insulating resin layers in a second direction perpendicular to the first direction in the mounting surface.

8. The coil component as claimed in claim 7, further comprising a third insulating resin layer covering the coil conductor so as to prevent the coil conductor from contacting the magnetic element body,
wherein each of the first and second insulating resin layers is lower in a dielectric constant than the third insulating resin layer.

9. A coil component having a mounting surface, the coil component comprising:
a magnetic element body;
a coil conductor embedded in the magnetic element body;
a first bump electrode connected to a first end of the coil conductor;
a second bump electrode connected to a second end of the coil conductor;
a first insulating resin layer surrounds an outer side surface of the first bump electrode perpendicular to the mounting surface such that a top surface of the first bump electrode is exposed on the mounting surface;
a second insulating resin layer surrounds an outer side surface of the second bump electrode perpendicular to the mounting surface such that a top surface of the second bump electrode is exposed on the mounting surface;
a first external terminal formed on the first insulating resin layer and contacting the top surface of the first bump electrode; and
a second external terminal formed on the second insulating resin layer and contacting the top surface of the second bump electrode,
wherein the first and second bump electrodes are arranged in a first direction parallel with the mounting surface,
wherein the outer side surface of the first bump electrode includes first and second outer side surfaces opposite to each other,
wherein the outer side surface of the second bump electrode includes third and fourth outer side surfaces opposite to each other,
wherein the first and third outer side surfaces face each other in the first direction,
wherein a first width in the first direction of the first insulating resin layer at a first portion covering the first outer side surface is smaller than a second width in the first direction of the first insulating resin layer at a second portion covering the second outer side surface, and
wherein a third width in the first direction of the second insulating resin layer at a third portion covering the third outer side surface is smaller than a fourth width in the first direction of the second insulating resin layer at a fourth portion covering the fourth outer side surface.

10. The coil component as claimed in claim 9,
wherein the outer side surface of the first bump electrode further includes a fifth outer side surface,
wherein the outer side surface of the second bump electrode further includes a sixth outer side surface,
wherein the first width is smaller than a fifth width in a second direction perpendicular to the first direction of the first insulating resin layer at a fifth portion covering the fifth outer side surface, and
wherein the third width is smaller than a sixth width in the second direction of the second insulating resin layer at a sixth portion covering the sixth outer side surface.

11. The coil component as claimed in claim 9,
wherein a part of the first portion is exposed on the mounting surface without being covered with the first external terminal, and
wherein a part of the third portion is exposed on the mounting surface without being covered with the second external terminal.

12. The coil component as claimed in claim 9, further comprising a third insulating resin layer covering the coil conductor so as to prevent the coil conductor from contacting the magnetic element body,
wherein each of the first and second insulating resin layers is lower in a dielectric constant than the third insulating resin layer.
